(19) United States
(12) Patent Application Publication
(10) Pub. No.: US 2004/0203654 A1
(43) Pub. Date: Oct. 14, 2004

(54) Method and system for obtaining information using a mobile communications device

(76) Inventors: Shelley L. Bass, Reno, NV (US); Michael A. Eifert, Reno, NV (US); Scott A. Ellwanger, Reno, NV (US); Charles E. Graves, Sparks, NV (US); John D. Werschey, Sparks, NV (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/262,463

(22) Filed: Sep. 30, 2002

(51) Int. Cl. H04M 11/10; H04M 3/42

(52) U.S. Cl. 455/414.1; 455/412.1

(57) ABSTRACT

According to one embodiment of the invention, a method for obtaining information for a client is provided. The method includes receiving, at an electronic mailbox accessible by a server, a request email comprising a description of information. The request email is sent by a remote client device that is located remote from the server. The information is stored in one or more of a plurality of databases. The method also includes automatically initiating transfer of the information from the one or more databases to the server using the description. The transfer is automatically initiated in response to receiving the request email. The method also includes receiving the information at the server. The method also includes automatically converting the information into a response email and automatically transmitting the response email to the remote client device after receiving the information from the one or more databases.

### TECHNICAL FIELD OF THE INVENTION

This invention relates generally to the field of communications and more particularly to a method and system for obtaining information using a mobile communications device.

### BACKGROUND OF THE INVENTION

A wide variety of mobile communications devices enable users to communicate in different ways. For example, cellular phones allow voice communication. Wireless personal digital assistants (“PDAs”) allow written communication using email and text messaging. There are also hybrid devices that may function as a cellular phone, a PDA, a web browser, and other communications devices, thus offering a variety of communication options to a user.

One of the capabilities of mobile communications devices is accessing information stored in remote databases. For example, a PDA may be used to obtain information from remote databases through web sites. However, PDAs and other mobile communications devices have limited display, memory and data processing capabilities due to the limitations in size, weight and battery power. Thus, storing and executing a web browser program in a mobile communications device may consume significant percentages of storage, processing and power capacities. Additionally, conventional web sites having graphics, color, pictures, and other features that require large quantities of memory, display space and power may not be accessible using mobile communications devices. Although it may be possible to manufacture mobile communications devices with more capabilities, the cost of manufacturing such devices is high.

### BRIEF DESCRIPTION OF THE DRAWINGS

Reference is now made to the following description taken in conjunction with the accompanying drawings, wherein like reference numbers represent like parts, in which:

FIG. 1 is a schematic diagram of one embodiment of a communications system that may benefit from the teachings of the present invention;

FIG. 2 is a block diagram of one embodiment of a client device shown in FIG. 1;

FIG. 3 is a block diagram of one embodiment of a server shown in FIG. 1;

FIG. 4 is a flow chart illustrating one embodiment of a method for obtaining information;

FIG. 5 is a flow chart illustrating additional details of one embodiment of the method of FIG. 4; and

FIGS. 6A and 6B are schematic diagrams illustrating one embodiment of the client device of FIGS. 1 and 2 performing some acts of the method of FIG. 4.

### DETAILED DESCRIPTION OF EXAMPLE EMBODIMENTS OF THE INVENTION

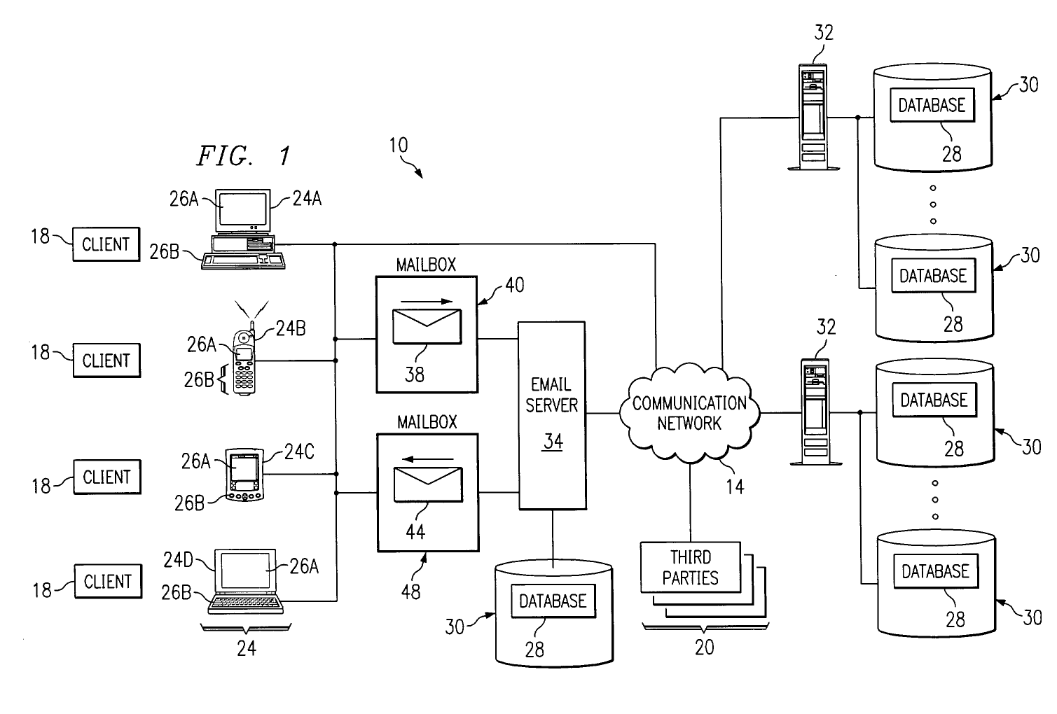

Embodiments of the invention are best understood by referring to FIGS. 1 through 6B of the drawings, like numerals being used for like and corresponding parts of the various drawings.

FIG. 1 illustrates a schematic diagram of an embodiment of a communications system 10 that may benefit from some embodiments of the present invention. System 10 comprises a communications network 14 that allows clients 18 to communicate with third parties 20 using one or more client devices 24. Using communications network 14, client 18 may also obtain data from databases 28 that are stored in one or more remote data storage units 30. Remote data storage units 30 may be accessible through one or more remote servers 32. Communications network 14 may be a network comprising internet, cable network, digital network, analog network, intranet, fiber optics network, or a combination of these and other suitable communication conduits. Client 18 may use a variety of client devices 24 to communicate with third parties 20 and/or remote servers 32 over communications network 14. Examples of client device 24 may include mobile communications devices, such as a Blackberry™ 24A available from Research In Motion Corporation, a wireless cellular phone 24B, a personal digital assistant (“PDA”) 24C, and a miniature laptop 24D. Each one of client devices 24 comprises an output unit 26A and an input unit 26B. Output unit 26A may be any type of display screen or speaker. Some client devices 24 may comprise more than one output unit 26A. For example, cellular phone 24B may have a liquid crystal display 26A as well as a speaker 26A. Input unit 26B may be any type of device for entering data into a computing device. Examples of input unit 26B include a keypad, a touchpad, a mouse, a trackball, and a microphone. Some client devices 24 may comprise more than one input unit 26B. For example, miniature laptop 24D may have a combination of a keyboard 26B and a trackball 26B. PDA 24C may also have a combination of input units 26B, such as buttons, a scroll wheel, and a writing pad which may be used in conjunction with a stylus to input alphanumeric characters. Client devices 24 may offer more than one form of communication for client 18. For example, cellular phone 24B may be used for voice communication as well as text communication using email or text messaging. To enhance their mobility, client devices 24 may be operable to conduct wireless communication with a base station, such as a server 34 that is coupled to communications network 14 by a physical connection.

Client devices 24 may also be operable to search for and access information stored in remote data storage units 30 by browsing web sites. For example, cellular 24B may be used to obtain information from databases 30 through web sites that are maintained by remote servers 32. Browsing web sites requires client device 24 to store and execute a web browser program, such as the Internet Explorer™ available from Microsoft Corporation. However, client devices 24 conventionally have limited display, memory, and data processing capabilities due to the limitations in size, weight and battery power. This is so that client devices 24 may be small and light enough to be mobile. Thus, storing and executing a web browser program may consume significant percentages of the already limited storage, processing and power capacities of client device 24. Additionally, conventional web sites having graphics, color, pictures and other features that require large quantities of memory, display space and power for proper display and navigation may not be accessible using most client devices 24. Although it may be possible to manufacture client devices 24 having greater memory, processing, and other capacities, the cost of manufacturing such client device 24 may be too high.

According to one embodiment of the invention, a method, system, and apparatus are provided that allow a client device to retrieve information from remotely located databases using email. This is advantageous in some embodiments of the invention because information stored in remote databases may be accessed using a client device without storing and running a program that may cause a substantial consumption of storage space, processing capacity or power. According to another embodiment, information may be obtained using a client device from a variety of databases regardless of whether the web sites associated with the databases have features that cannot be adequately handled by the client device. Additional details of example embodiments of the invention are described in greater detail below in conjunction with portions of FIG. 1 and FIGS. 2 through 6B.

Referring back to FIG. 1, in one embodiment of the invention, client device 24 is operable to send to an electronic mailbox 40 a request email 38 that comprises a request for information and a description of the requested information. Server 34 polls mailbox 40 to determine whether request email 38 has been received. After determining that request email 38 has been received, server 34 identifies the location of the requested information using the description of the requested information and automatically initiates transfer of the described information from the identified location to server 34. After receiving the information, server 34 converts the received information into a response email 44 and sends response email 44 to an electronic mailbox 48 of the particular client device 24 that sent the request email 38.

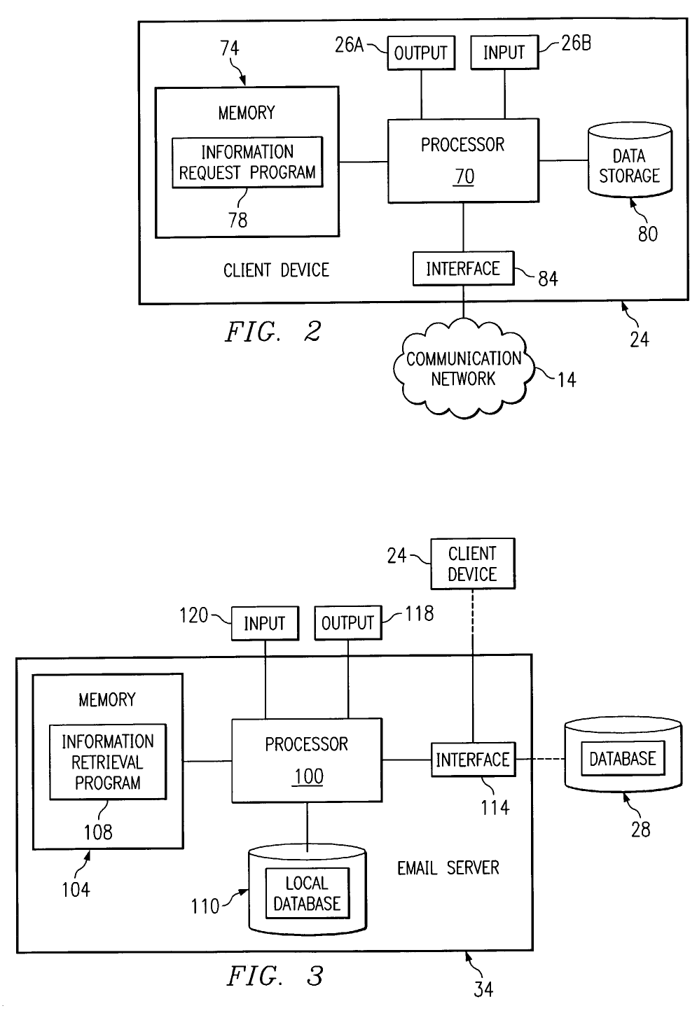

FIG. 2 is a block diagram illustrating one embodiment of client device 24 shown in FIG. 1. Client device 24 may be any one of client devices 24A through 24D or any other mobile communications device operable to conduct communication using communications network 14. Client device 24 comprises a processor 70, a memory 74 storing an information request program 78, and one or more local data storage units 80 for storing data related to program 78 or other data. Client device 24 may also comprise a communications interface 84, such as a modem or other suitable network interface devices operable to provide a wireless connection between client device 24 and communications network 14. Processor 70 is coupled to memory 74, local data storage unit 80, and interface 84. Processor 50 is also coupled to output unit 26A and input unit 26B. Processor 70 is operable to execute the logic of information request program 78. Examples of processor 70 are Intel 386™ processors, available from Intel Corporation.

Memory 74 and data storage unit 80 may comprise files, databases, or other suitable forms of data. Memory 74 and data storage unit 80 may be random access memory, read only memory, removable memory devices, or any other suitable devices that allow storage and/or retrieval of data. Memory 74 and data storage unit 80 may be interchangeable and may perform the same functions.

Information request program 78 is a computer program that allows client 18 to select a category of available information, prompt client 18 to describe the selected category of information, if necessary, and automatically generate and send request email 38 to mailbox 40. Information request program 78 may reside in any storage medium, such as memory 74 and data storage unit 80. Although FIG. 3 shows program 78 as a software program, program 78 may also be programmed in a variety of hardware, such as a digital signal processor, application specific integrated circuit, or other suitable hardware. Information display program 78 may be written in any suitable language, including C and C++. An example of program 78 that may incorporate some embodiments of the present invention is SBC Rover™, available from SBC technology. Using information request program 78 is advantageous in some embodiments of the invention because program 78 allows retrieval of information from databases located away from client device 24 without requiring a substantial percentage of client device's 24 storage, processing, display, and power capacities. By using email to request information from server 34, the tasks of navigating and searching for information are shifted from client device 24 to server 34. Further, in some embodiments, the task of converting information into a format displayable by client device 24 is also shifted to server 34. Because server 34 does not have the mobility requirement of client device 24, shifting tasks from client device 24 to server 34 allows client device 24 to retrieve information from remotely located databases 28 using program 78 that requires less memory, processing capacity and power than a conventional web browser program.

FIG. 3 is a block diagram illustrating one embodiment of server 34 shown in FIG. 1. Server 34 may be any computer or other computing device operable to poll mailbox 40 to determine whether request email 38 has been received, retrieve the information that is described in request email 38 from one or more of remote databases 28, and send response email 44 that includes the retrieved information to mailbox 48 of client device 24. In one embodiment, remote databases 28 are accessible through remote servers 32. Server 34 comprises a processor 100, a memory 104 storing an information retrieval program 108, and a local data storage unit 110 for storing data related to program 108 or other data. Server 34 may also comprise a communications interface 114, such as a modem or other suitable network interface devices operable provide a line of communication between server 34 and client device 24 or other parties coupled to communications network 14, such as remote servers 32. Processor 100 may also be coupled to an output unit 118, such as a monitor, and an input unit 120, such as a keyboard or a mouse. Processor 100 is operable to execute the logic of information retrieval program 108. Examples of processor 100 are Pentium™ processors, available from Microsoft corporation.

Memory 104 and local data storage unit 110 may comprise files, databases, or other suitable forms of data. Memory 104 and local data storage unit 110 may be random access memory, read only memory, CD-ROM, removable memory devices, or any other suitable devices that allow storage and/or retrieval of data. Memory 104 and local data storage unit 110 may be interchangeable and may perform the same functions.

In one embodiment, information retrieval program 108 is a computer program that is operable to poll mailbox 40 to determine whether request email 38 has been received, determine the category and the description of the information that is requested through request email 38, contact one or more remote servers 32 to initiate transfer of the described information from one or more databases 28 stored in remote data storage units 30, and automatically generate and send response email 44 that includes the transferred information to client device 24. Information retrieval program 108 may reside in any storage medium, such as memory 104 and data storage unit 110. Although FIG. 3 shows program 108 as a software program, program 78 may also be programmed in a variety of hardware, such as a digital signal processor, application specific integrated circuit, or other suitable hardware. Information display program 78 may be written in any suitable language, including C and C++. Examples of program 108 that may incorporate some embodiments of the present invention include Rover PS™, Rover SI™, Rover News™, Rover DD™, and Rover CW™, available from SBC technology.

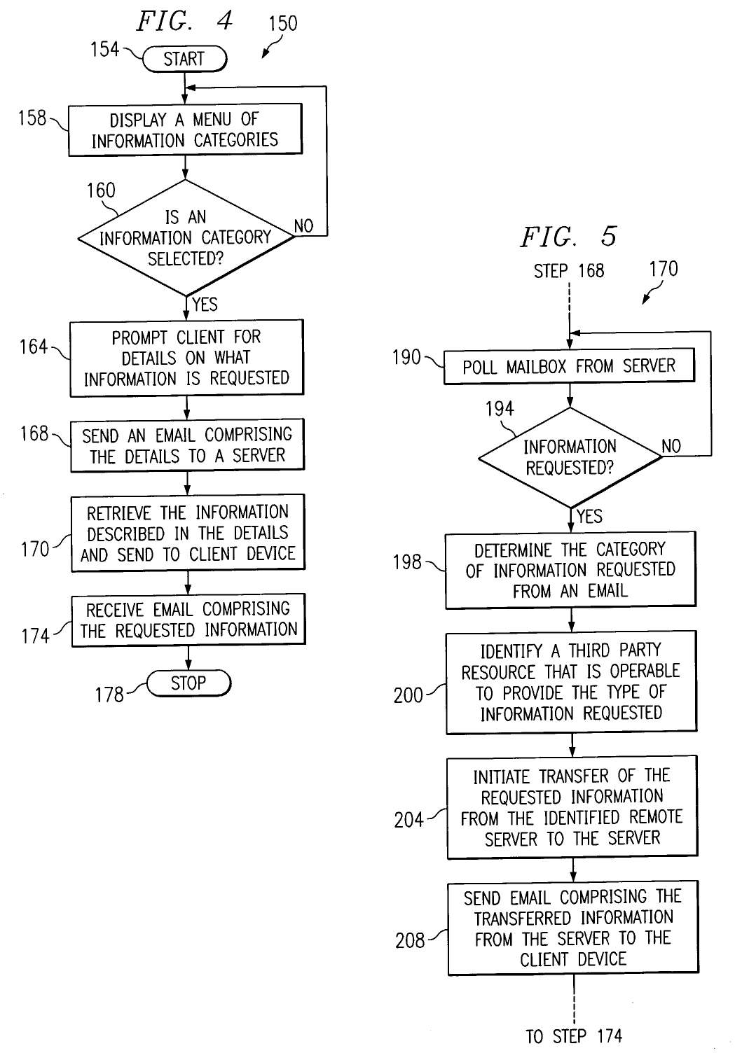

FIG. 4 is a flow chart illustrating one embodiment of a method 150 for obtaining information. In one embodiment, some acts of method 150 may be implemented using information request program 78 and information retrieval program 108. Method 150 starts at step 154. At step 158, a menu of information categories are displayed through display unit 26A of client device 24. Any category of information may be displayed as a part of the menu at step 158. For example, categories of information may include stock information, weather information, driving directions, contact information of persons, chain of command of a particular organization, or any other information that may be of interest to a particular client 18. Using any applicable portion of input unit 26B, client 18 may scroll up or down to highlight or select a category of information that is available. At decision step 160, whether an information category is selected is determined. If no, then the “No” branch is followed back to step 158. If yes, then “Yes” branch is followed to step 164. At step 164, client 18 is prompted for details that would describe the requested category of information. For example, if “weather information” category is selected, then client 18 may be prompted to input information that would indicate a particular location so that the weather information of the particular location may be requested. In some embodiments, step 164 may be omitted. For example, if “stock information” category is selected, the stock information of all or a preselected number of companies may be automatically transferred to client device 24 without any further input from client 18. At step 168, once the category of information is selected and/or the required input is provided that describes the requested information, request email 38 comprising these details is automatically sent to mailbox 40. At step 170, server 34 receives request email 38, automatically locates one or more of a plurality of remote servers 32 that can access the described information from remote databases 28 stored in remote data storage units 30, and automatically initiates a transfer of the described information to server 34. Additional details of step 170 are provided below in conjunction with FIG. 5. In some embodiments, certain information may be located in remote database 28 that is directly accessible by server 34 without going through remote server 32, as shown in FIG. 1. At step 174, response email 44 comprising the requested information is received at client device 24. Method 150 concludes at step 178.

Retrieving information from remote data storage units 38 using email is advantageous in some embodiments of the invention because client devices 24 may take advantage of existing capabilities, such as sending and receiving email, to retrieve data from remote databases 28 that may not otherwise be available without a substantial increase of computing capabilities of client devices 24. In some embodiments of the invention, the need to upgrade display units 26A is eliminated because information included in response to email is converted by server 34 into a format that is displayable on existing display units 26A.

FIG. 5 is a flow chart illustrating one embodiment of step 170 of FIG. 4. Step 170 may be performed in some embodiments by information retrieval program 108 of server 34. At step 190, server 34 polls electronic mailbox 40 to which client device 24 may send request email 38. At decision step 194, whether request email 38 has been received is determined. If no, then “No” branch is followed back to step 190. If yes, then “Yes” branch is followed to step 198. At step 198, server 34 automatically determines the type of information that is requested from request email 38. For example, in one embodiment, a designated field within request email 38 may contain a category indicator. Client device 24 selects a category indicator for request email 38 depending on the category of information shown in a menu that was selected by client 18. For example, client device 24 may insert a character string “driving directions” as a category indicator in a particular field of request email 38 that server 34 would look at to determine the category of information requested. Depending on the identified category indicator, other fields within request email 38 may include appropriate input information entered by client 18 that describe the requested information. At step 200, based on the description of the requested information included in request email 38, server 34 may automatically identify one or more resources, such as a particular remote server 32 that has access to the described information or remote data storage unit 30.

Then at step 204, server 34 initiates the transfer of the type of information that is requested from the identified remote server 32 to server 34. In one embodiment, server 34 may be operable to automatically transfer the information in the particular fields of request email 38 that contains the description of the requested information over to the corresponding input fields of a web site maintained by a corresponding remote server 32. Upon receiving the description of the requested information from server 34, remote server 32 retrieves the requested information from database 28 stored in data storage unit 30 and transfers it over communications network 14 to server 34. In one embodiment, server 34 may identify data storage unit 30 that can be directly accessed by server 34 and retrieve the described information from database 28 stored in data storage unit 30. At step 208, server 34 automatically sends response email 44 that comprises the information to client device 24 using mailbox 48. In one embodiment, the information may be converted into a format displayable by client device 24. For example, server 34 may convert the received information from data storage unit 30 into a text format, such as plain text, rich text, or any other format that may be displayed by output unit 26A of a particular client device 24.

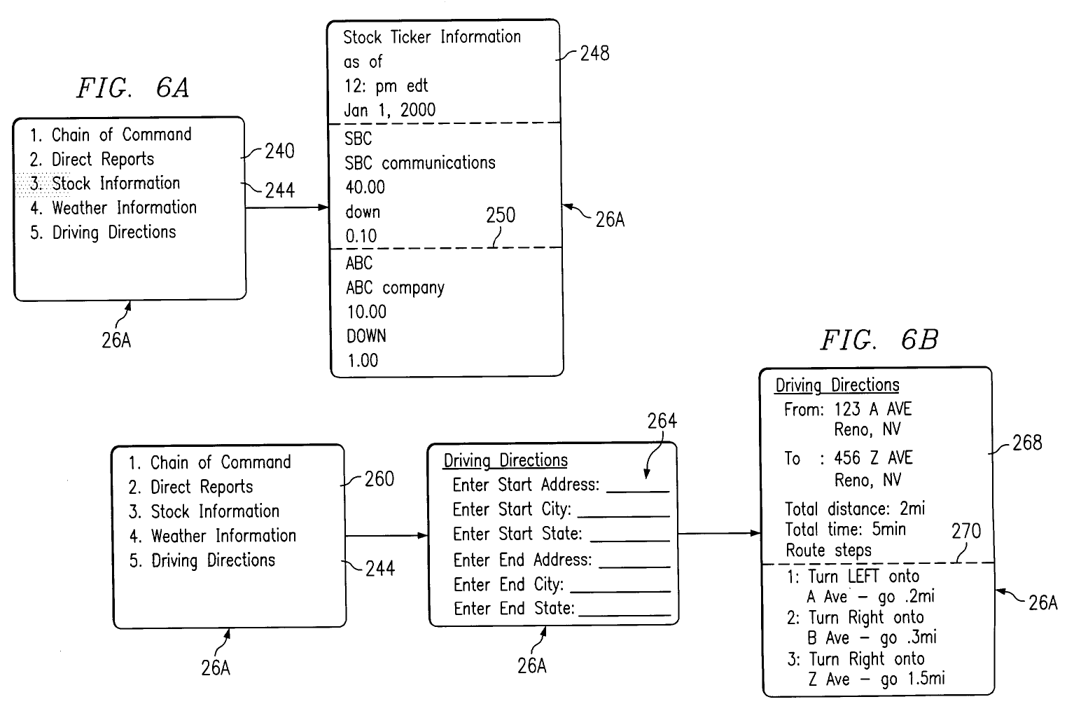

FIGS. 6A and 6B are schematic diagrams illustrating one embodiment of client device 24 of FIGS. 1 and 2 performing portions of method 150 of FIG. 4. FIG. 6A shows screen 26A displaying a menu 240 of information categories that is generated by client device 24. In the example shown in FIG. 6A, menu 240 shows the categories identified as “chain of command,” “direct reports,” “stock information,” “weather information,” and “driving direction.” Although only five categories of information are listed in menu 240, other categories of information may also be included as a part of menu 240. Any one of these categories may be selected by scrolling up or down and highlighting, using a highline block 244, a category of information. For example, FIG. 6A shows that “stock information” is selected using highlight bar 244. In one embodiment where no input by client 18 is required, request email 38 is sent to server 34 after the category is selected. Then server 34 sends response email 44 that comprises requested information 248. In one embodiment, response email 44 comprises stock ticker information for various companies. The list of stock information may not fit at one time within the space of display screen 26A. Client 18 may scroll up and down the entirety of the list using a portion of input device 26B. For example, as shown in FIG. 6A, the displayed portion of requested information 248 is shown above a phantom line 250. However, information below phantom line 250 may be viewed using input device 26B.

In another embodiment, as shown in FIG. 6B, display screen 26A displays a menu 260 comprising a set of categories of information. Menu 260 is generated by client device 24. In this example, a category identified as “driving directions” is selected using highlight bar 244. Upon the selection of driving directions, client device 24 displays one or more fields 264 in which client 18 is prompted to enter the description of the information. For example, descriptive information concerning the start address, the start city, the start state, the end address, the end city, and the end state are requested from client 18, as shown in FIG. 6B. The resulting response email 44 may comprise requested information 268 which shows the driving directions. The portion of requested information 268 that may be displayed at one time through display screen 26A is shown above a phantom line 270. However, the portions that are shown below phantom line 270 may be viewed by scrolling up or down using input device 26B.

Although some embodiments of the present invention have been described in detail, it should be understood that various changes, substitutions, and alterations can be made hereto without departing from the spirit and scope of the invention as defined by the appended claims.

What is claimed is:

1. A method for obtaining information for a client, comprising:
receiving, at an electronic mail box accessible by a server, a request email comprising a description of information, the request email sent by a remote client device, the information stored in one or more databases accessible by a remote server and not directly accessible by the server, the remote server and the remote client device located remote from the server;
in response to receiving the request email, automatically determining, at the server, an address of the remote server using the description of the information in the request email;
automatically sending, from the server, a request for the information to the remote server using the determined address of the remote server;
in response to sending the request, receiving the information at the server; and
after receiving the information from the one or more databases, automatically converting the information into a response email and automatically transmitting the response email to the remote client device.

2. The method of claim 1, and further comprising converting the information into a text format.

3. The method of claim 1, and further comprising displaying, at the remote client device, a menu identifying one or more categories of information;
automatically generating the request email at the remote client device after the client selects one of the identified categories of information in the menu, the request email comprising an information category indicator indicative of the selected one of the categories of information; and
automatically sending the request email to the electronic mailbox.

4. The method of claim 1, wherein the description of information comprises an information category indicator, and automatically determining an address of the remote server comprises comparing the information category indicator to a register maintained at the server, the register comprising the same information category indicator and the corresponding address of the remote server.

5. A method for obtaining information for a client, comprising:
receiving, at an electronic mailbox accessible by a server, a request email comprising a description of information, the request email sent by a remote client device that is located remote from the server, the information stored in one or more of a plurality of databases;
using the description, automatically initiating transfer of the information from the one or more databases to the server, the transfer automatically initiated in response to receiving the request email, and receiving the information at the server; and
after receiving the information from the one or more databases, automatically converting the information into a response email and automatically transmitting the response email to the remote client device.

6. The method of claim 5, and further comprising polling the electronic mailbox from the server to determine that the request email is received at the electronic mailbox.

7. The method of claim 5, and further comprising converting the information into a text format.

8. The method of claim 5, wherein the one or more of the databases are not directly accessible by the server and the description of information comprises an information category indicator, the same information category indicator maintained at the server in conjunction with a corresponding address of a remote server, the remote server having access to the one or more databases storing the information.

9. The method of claim 5, and further comprising displaying, at the remote client device, a menu of one or more categories of information.

10. The method of claim 5, and further comprising
displaying, at the remote client device, a menu identifying one or more categories of information;
automatically generating the request email at the remote client device after the client selects one of the identified categories of information in the menu, the request email comprising an information category indicator indicative of the selected one of the categories of information; and
automatically sending the request email to the electronic mailbox.

11. The method of claim 5, wherein the client device is a wireless email transceiver.

12. The method of claim 5, wherein the one or more of the databases are not directly accessible by the server, the description of information comprises an information category indicator, and wherein automatically initiating transfer of the information from the one or more databases to the server comprises:
identifying, at the server, an address of the remote server using a register maintained at the server, the register comprising the information category indicator and the corresponding address of the remote server, the remote server having access to the one or more databases storing the information; and
sending a request to the remote server using the identified address.

13. A system for obtaining information for a client, comprising:
a computer system having a processor;
a computer readable medium coupled to the computer system, the computer readable medium comprising a program operable, when executed on the processor, to:
determine that a request email is received at an electronic mailbox, the request email comprising a description of information sent by a remote client device that is located remote from the computer system, the information stored in one or more of a plurality of databases;
using the description, automatically initiate transfer of the information from the one or more databases to the computer system, the transfer automatically initiated in response to receiving the request email, and receive the information; and
after receiving the information from the one or more databases, automatically convert the information into a response email and automatically transmit the response email to the remote client device.

14. The system of claim 13, wherein the program is operable to determine that a request email is received by polling the electronic mailbox.

15. The system of claim 13, wherein the program is further operable to automatically convert the information into a text format.

16. The system of claim 13, wherein the one or more of the databases are not directly accessible by the computer system and the description of information comprises an information category indicator, the same information category indicator maintained at the computer system in conjunction with a corresponding address of a remote server, the remote server having access to the one or more databases storing the information.

17. The system of claim 13, and further comprising a client device wirelessly coupled to the computer system, the client device operable to display a menu of one or more categories of information.

18. The system of claim 13, wherein the processor is a first processor and the computer readable medium is a first computer readable medium, and the remote client device is wirelessly coupled to the computer system, the remote client device having a display unit, a second processor and a second computer storage medium, the second computer readable medium comprising a request program operable, when executed on the second processor, to:
display, using the display unit, a menu identifying one or more categories of information;
automatically generate the request email after the client selects one of the identified categories of information in the menu, the request email comprising an information category indicator indicative of the selected one of the categories of information; and
automatically send the request email to the electronic mailbox.

19. The system of claim 13, wherein the remote client device is a Blackberry™.

20. The system of claim 13, wherein the one or more of the databases are not directly accessible by the computer system, the description of information comprises an information category indicator, and wherein the program is operable to automatically initiate transfer of the information from the one or more databases to the computer system by:
identifying, at the server, an address of the remote server using a register maintained at the server, the register comprising the information category indicator and the corresponding address of the remote server, the remote server having access to the one or more databases storing the information; and
sending a request to the remote server using the identified address.
